(19) United States
(12) Patent Application Publication
(10) Pub. No.: US 2010/0042719 A1
(43) Pub. Date: Feb. 18, 2010

(54) Content access to virtual machine resource

(76) Inventor: Junji Kinoshita, Sunnyvale, CA (US)

Correspondence Address: MATTINGLY & MALUR, P.C., 1800 DIAGONAL ROAD, SUITE 370, ALEXANDRIA, VA, 22314, US

(21) Appl. No.: 12/222,561

(22) Filed: Aug. 12, 2008

(51) Int. Cl. G06F 15/16

(52) U.S. Cl. 709/225

(57) ABSTRACT

The storage system extracts virtual machine resource files based on sources of accesses. In one embodiment, a storage system comprises a network attached storage (NAS) device which is connected to a plurality of computer devices via a network. The NAS device is configured, (i) in response to a request to access a virtual machine resource which is recognized by the NAS device through identification information associated with the request as one that does not require content access to the virtual machine resource, to show the virtual machine resource without content access; and (ii) in response to a request to access a virtual machine resource which is recognized by the NAS device through identification information associated with the request as one that requires content access to the virtual machine resource, to show the virtual machine resource with content access.

### BACKGROUND OF THE INVENTION

The present invention relates generally to information technology (IT) systems utilizing server virtualization and storage systems and, more particularly, to methods and apparatus of allowing a storage system to extract virtual machine resources based on sources of accesses by controlling the view of the resources.

Global warming has been recognized as an increasingly serious problem. Many companies and organizations now have concerns about energy consumption of their IT systems.

In general, there are various solutions for reducing energy consumption of IT systems. Virtualization technology is considered to be one of them. Using virtualization technology, IT system administrators can consolidate multiple physical servers into one physical server by running multiple virtualized servers on the physical server. Resources of virtual servers, necessary for virtual servers to provide their services (e.g., operating system data, service application data, system configuration data, and so forth), are usually packed in a couple of files on a physical server and the storage system. Portability of these resource files allows virtual servers to dynamically move from one physical server to another physical server to achieve load balancing, high availability, and so forth (e.g., VMware's VMotion). Moreover, physical servers can be migrated to virtual servers and vice versa. As a result, IT system administrators can raise server utilization in their IT systems.

On the other hand, many companies and organizations usually check contents of their data for the purpose of data archiving, virus scanning, and so forth. In terms of data archiving, they have to archive their data for a certain period, so that they can prepare for possible future litigations or meet some regulations or compliance requirements or the like. To leverage archived data effectively, some additional information is usually created for the data when the data is archived. For example, metadata such as the title of a medical image and search index information help companies and organizations to organize their data or to quickly find data. Adding those kinds of information allows an archiving system to scan and understand contents of data.

During archiving, a number of files might be contained within other files as described above. Currently, data archiving systems cannot create appropriate metadata or search index information for files contained within other files. From the archiving system perspective, resource files of virtual servers are likely to be big files, and it is very cumbersome for the archiving system to retrieve files out of the resource files.

### BRIEF SUMMARY OF THE INVENTION

Embodiments of the invention provide apparatus and methods for the storage system to extract virtual machine resource files based on sources of accesses by controlling the view of the resources. A storage system including a storage device and a server management computer allows an administrator to set resource view control information in the storage system. Using the resource view control information, the storage device controls the way of showing a resource for each server. If a server needs to access only a resource itself as stored in the storage device, the storage device shows the resource as just a file to the server with no content access. If a server needs to access data contained within a resource, the storage device mounts the resource in its filesystem and directly shows the contained data to the server (i.e., with content access). The server management computer can provide the resource view control information to the storage device. The server management computer manages the location and movement of servers including physical computers and virtualized servers, and it can also update the resource view control information in response to a change in status of any of the computers and servers.

In accordance with an aspect of the present invention, a storage system comprises a network attached storage (NAS) device which is connected to a plurality of computer devices via a network. The NAS device is configured, (i) in response to a request to access a virtual machine resource which is recognized by the NAS device through identification information associated with the request as one that does not require content access to the virtual machine resource, to show the virtual machine resource without content access; and (ii) in response to a request to access a virtual machine resource which is recognized by the NAS device through identification information associated with the request as one that requires content access to the virtual machine resource, to show the virtual machine resource with content access through which the computer device can directly refer to one or more files contained within the virtual machine resource.

In some embodiments, the request which does not require content access to the virtual machine resource is sent from a computer device or a part of a computer device that provides a server virtualization platform. The request which requires content access to the virtual machine resource is sent from a computer device or a part of a computer device that provides services such as data archiving, security checking, and so forth. A computer device can be used for multi-purposes. The NAS device recognizes the source of access through network identification information or some other identification information (e.g., IP address, network filesystem authentication information, and the like) associated with each sender or source of access which sends the request, such as server virtualization platform, data archiving service, security check service, and so forth.

In some embodiments, the NAS device includes a resource view control table which stores information on whether to show the virtual machine resource with content access or without content access for each of the plurality of computer devices connected to the NAS device. The NAS device refers to the resource view control table to determine whether to show the virtual machine resource with content access or without content access in response to a request from any of the plurality of computer devices. The resource view control table further stores information to show data other than virtual machine resource without content access in response to a request from any of the plurality of computer devices. One of the plurality of computer devices connected to the NAS device via the network is a management computer device which is configured to update the resource view control table in response to a change in status of any of the plurality of computer devices.

In specific embodiments, one of the plurality of computer devices is a physical computer device which is made into a virtual machine by migration, a new virtual machine resource is created in the NAS device, and resource used by the physical computer device is copied into the new virtual machine resource. The management computer device updates the resource view control table to indicate a change in status of the resource from the resource used by the physical computer device to the new virtual machine resource.

In some embodiments, one of the plurality of computer devices connected to the NAS device via the network is an archive computer device which is configured to access one or more resources in the NAS device. The NAS device is configured to show a resource to be accessed by the archive computer device without content access if the resource is data other than virtual machine resource, and to show a resource to be accessed by the archive computer device with content access if the resource is a virtual machine resource.

In specific embodiments, one of the plurality of computer devices connected to the NAS device via the network is a management computer device which is configured to provide resource view control information to the NAS device specifying whether to show the virtual machine resource with content access or without content access for each of the plurality of computer devices connected to the NAS device. The management computer device includes a resource view control table that stores information on whether to show the virtual machine resource with content access or without content access for each of the plurality of computer devices connected to the NAS device. The management computer device is configured to update the resource view control table in response to a change in status of any of the plurality of computer devices.

In accordance with another aspect of the present invention, a storage system comprises a network attached storage (NAS) device which is connected to a plurality of computer devices via a network. The NAS device includes a virtual machine resource and data other than virtual machine resource. In response to a request to access the virtual machine resource from a computer device on which a virtual machine runs, the NAS device is configured to show the virtual machine resource without content access. In response to a request to access the virtual machine resource from a computer device on which no virtual machine runs, the NAS device is configured to show the virtual machine resource with content access through which the computer device can directly refer to one or more files contained within the virtual machine resource. In response to a request to access data other than the virtual machine resource from any of the plurality of computer devices, the NAS device is configured to show the data without content access.

Another aspect of the present invention is directed to a method of controlling view of resources in a network attached storage (NAS) device for a storage system in which a plurality of computer devices are connected to the NAS device via a network. The method comprises, in response to a request to access a virtual machine resource from a computer device which does not require content access to the virtual machine resource, showing the virtual machine resource without content access; and, in response to a request to access a virtual machine resource from a computer device which requires content access to the virtual machine resource, showing the virtual machine resource with content access through which the computer device can directly refer to one or more files contained within the virtual machine resource.

In specific embodiments, the method further comprises providing in the NAS device a resource view control table which stores information on whether to show the virtual machine resource with content access or without content access for each of the plurality of computer devices connected to the NAS device; and referring to the resource view control table to determine whether to show the virtual machine resource with content access or without content access in response to a request from any of the plurality of computer devices. The method may further comprise, in response to a request to access data other than virtual machine resource from any of the plurality of computer devices, showing the data without content access. The method may comprise updating the resource view control table in response to a change in status of any of the plurality of computer devices. The method may further comprise obtaining, from a management computer device which is connected to the NAS device via the network, resource view control information specifying whether to show the virtual machine resource with content access or without content access for each of the plurality of computer devices connected to the NAS device.

These and other features and advantages of the present invention will become apparent to those of ordinary skill in the art in view of the following detailed description of the specific embodiments.

### BRIEF DESCRIPTION OF THE DRAWINGS

FIG. 1 illustrates an example of the hardware and software structure of a storage system according to an exemplary embodiment of the present invention.

FIG. 2 illustrates an example of the data structure of the resource view control table of the invention.

FIGS. 3a and 3b show example structures of the filesystem in a network attached storage (NAS) device.

FIG. 4 shows an example structure of a virtual disk file which is a type of virtual machine resource files.

FIG. 5 illustrates an exemplary process for updating the resource view control table.

FIG. 6 illustrates an exemplary process for controlling the view of resources.

FIG. 7 illustrates an exemplary process for archiving resources of servers within the network attached storage device into the data archive storage device.

FIG. 8 illustrates an example of the hardware and software structure of a storage system according to another embodiment of the present invention.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment”, “this embodiment”, or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for extracting virtual machine resource files based on sources of accesses by controlling the view of the resources.

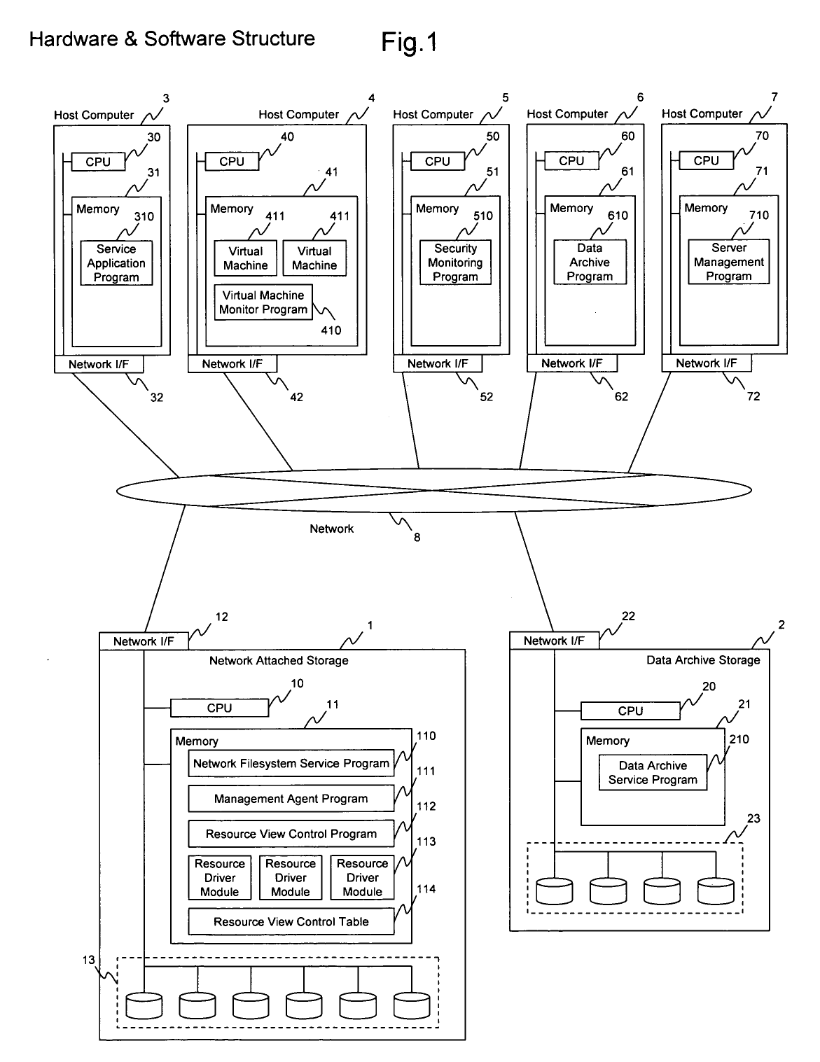

FIG. 1 illustrates an example of the physical hardware and logical software architecture of a storage system according to an exemplary embodiment of the present invention. A network attached storage (NAS) device 1 is connected to a data archive storage device 2 and a plurality of host computers via a network 8. In this embodiment, there are five host computers 3-7. The NAS device 1 has a CPU 10, a memory 11, a network interface 12, and a logical volume 13. The data archive storage device 2 has a CPU 20, a memory 21, a network interface 22, and a logical volume 23. The host computer 3 is a service application server and includes a CPU 30, a memory 31, and a network interface 32. The host computer 4 is a virtualization server and includes a CPU 40, a memory 41, and a network interface 42. The host computer 5 is a security server and includes a CPU 50, a memory 51, and a network interface 52. The host computer 6 is a data archive server and includes a CPU 60, a memory 61, and a network interface 62. The host computer 7 is a server management device and includes a CPU 70, a memory 71, and a network interface 72. In this embodiment, each host computer has one service and one network interface; in other embodiments, however, a host computer can be used for multi-purposes so that several services are consolidated in one host computer and provided through one or more network interfaces in actual environments.

In general, the NAS device 1 is used for storing data via networks. It exports a part of its filesystem to the servers, which can be either physical host computers or virtual machines, using a network filesystem interface so that the servers can store and share their files on the NAS device 1.

There are various purposes for using the NAS device 1. For example, the host computer 4 has a virtual machine monitor program 410 that stores virtual machine resource files of virtual machines 411 into the NAS device 1, along with various other types of files using a network filesystem interface such as NFS, CIFS, and so forth. A virtual machine resource file, as described later, includes data necessary for a virtual machine to boot up and run, and can contain a lot of files within it. The host computer 3 can also store its resources and data in the NAS device 1. When the NAS device 1 receives access requests from the host computers to these files including virtual machine resource files as well as data other than virtual machine resource files such as physical machine resource files, the NAS device 1 needs to show them to the various host computers.

On the other hand, the host computer 5 performs security check against data stored within the NAS device 1. The host computer 6 archives data stored within the NAS device 1 into the data archive storage device 2. These host computers need to refer to contents of virtual machine resource files so that they can recognize files contained within the virtual machine resource files and provide their service to them. When the NAS device 1 receives access requests from these host computers that require content access, to the virtual machine resource files, the NAS device 1 shows the files contained within these virtual machine resource files. An administrator can define the way of showing each file to each host computer via the server management host computer 7.

As seen in FIG. 1, the NAS device 1 includes at least one CPU 10, at least one memory 11, and at least one network interface 12 that is used for connecting to the network 8. The logical volume 13 is comprised of a plurality of one or more physical storage mediums such as HDD (hard disk drive), flash memory, optical disk, tape, and the like. The NAS device 1 builds its filesystem and contains data files in the logical volume 13. Some of them can be virtual machine resource files of virtual machines running on the host computers. A number of software programs run on the NAS device 1. These programs and information used by the programs are stored in the memory 11. The CPU 10 executes the programs.

The network filesystem service program 110 provides an interface that allows the servers to store data in the NAS device 1. The interface can be one of the usual network filesystem mechanisms such as NFS and CIFS. In this embodiment, it also refers to the resource view control table 114 and invokes the resource view control program 112, if it receives an access request from a server to a virtual machine resource file or a shared directory containing virtual machine resource files, and the server needs to directly access files contained within a virtual machine resource file as defined in the resource view control table 114.

The management agent program 111 provides an interface that allows an administrator to set resource view control information to the resource view control table 114 within the NAS device 1 via the server management program 710 in the server management device 7. Using the resource view control information, an administrator can define the way of showing files of the NAS device 1 to the various servers.

The resource view control program 112 provides a way of switching the view of the files. It is invoked by the network filesystem service program 110 if necessary, and it refers to the resource view control table 114 to determine the type of the virtual machine resource file. After that, it loads a proper resource driver module 113 and mounts the virtual machine resource files so that some servers can directly view files contained within the virtual machine resource files using an ordinary network filesystem interface.

The NAS device 1 may contain various types of virtual machine resource files. The resource driver modules 113 help the resource view control program 112 to analyze the formats of various types of virtual machine resource files. Using the resource driver modules 113, the resource view control program 112 can understand the structures of virtual machine resource files and mount them in a filesystem of the NAS device 1.

The resource view control table 114 defines the resource view control information that is set by an administrator via the server management program 710 and the management agent program 111. The resource view control information is used by the network filesystem service program 110 and the resource view control program 112. When the NAS device 1 receives an access request from a server to a file stored within it, the network filesystem service program 110 refers to this table 114 to determine whether the NAS device 1 should show files contained within the virtual machine resource to the server. This table 114 is updated in certain circumstances including, for example, a change of network identification information of any of the servers due to virtual machine movement or server migrations, a change of resource information of any of the servers, and so forth.

The data archive storage device 2 is used for preserving data for a certain period. This achieves various purposes. Some may store the data in the data archive storage device 2 for the purpose of preparing for possible litigation. Some may use the data archive storage device 2 to meet certain regulations and compliance programs. To accommodate those intended uses, the data archive storage device 2 can have data protection functions such as WORM (Write Once Read Many) or data retention. The data archive storage device 2 can also create some additional information when it archives data to help users leverage data effectively, as well as the data archive program 610 of the data archive host computer 6 does. For example, the data archive storage device 2 can create metadata and search index information based on the contents of each file, so that users can easily find appropriate file from a huge amount of files.

In the embodiment of FIG. 1, the data archive storage device 2 is used to archive resources of servers including files contained within virtual machine resource files. The data archive program 610 of the host computer 6 retrieves files from the NAS device 1, creates some additional information based on contents of files, and put them into the data archive storage device 2. The data archive storage device 2 also can create some additional information for archived files based on contents of the files and preserve them. To achieve this purpose, the data archive program 610 and the data archive storage device 2 need to have the capability to access contents of files contained within virtual machine resource files as well as contents of ordinary files (i.e., physical machine resource files). According to an aspect of the present invention, the NAS device 1 allows the data archive program 610 to directly access contents of these files using an ordinary network filesystem interface. As a result, the data archive storage device 2 receives files contained within the virtual machine resource files from the data archive program 610.

The data archive storage device 2 has at least one CPU 20, at least one memory 21 and at least one network interface 22, and one or more logical volumes 23. The data archive storage device 2 stores data in the logical volume 23. Some data may contain a lot of other data such as resource files of virtual machines. Software programs run on the data archive storage device 2. Those programs and information used by the programs are stored in the memory 21. The CPU 20 executes the programs.

The data archive service program 210 provides interfaces of storing data in the data archive storage 2. In this embodiment, the data archive program 610 retrieves data out of the NAS device 1 and stores them in the data archive storage device 2 using the interface provided by the data archive program 610. The interface can be proprietary or one of the usual network filesystem mechanisms such as NFS and CIFS. It can also create additional information such as metadata or search index information based on the contents of the files when it receives the files.

The host computer 3 is a service application server that provides a specific kind of service such as web service, mail service, or the like. It can store various types of data into the NAS device 1 using network filesystem client functionality provided by operating system. The host computer 3 includes at least one CPU 30, at least one memory 31, and at least one network interface 32. Software programs run on the host computer 3. The programs and information used by the programs are stored in the memory 31. The CPU 30 executes the programs. The service application program 310 provides the specific kind of service of the host computer 3.

The host computer 4 is a virtualization server that provides a server virtualization platform so that virtual machines 411 can run on the host computer 4. The host computer 4 includes at least one CPU 40, at least one memory 41, and at least one network interface 42. Software programs run on the host computer 4. The programs and information used by the programs are stored in the memory 41. The CPU 4 executes the programs.

The virtual machine monitor program 410 provides a server virtualization platform that enables multiple virtual machines 411 to run on a host computer at the same time. It can show virtualized hardware resources (e.g., hard disk, memory, network interface, and so forth) to the virtual machines 411. It stores virtualized storage resources into the NAS device 1 as virtual machine resource files using a network filesystem interface such as NFS, CFS, and the like. Network filesystem client capability, which is used for accessing the NAS device 1, can be provided by either the virtual machine monitor program 410 or operating system of the host computer 4. It may have the capability to move a virtual machine 411 running on a host computer to another host computer, and to migrate a virtual machine 411 to be a host computer and vice versa. The server management program 710 on the server management host computer 7 or an administrator can require movement of the virtual machine 411 and migration of servers to virtual machines via the virtual machine monitor program 410.

The virtual machine 411 is a type of server and may be a software process and partition of a portion of the resources of the host computer in which the partitioned computer resources are caused to act as an individual host computer. Thus, a number of instances of virtual machines 411 may be created on a single host computer. In this embodiment, resources of each virtual machine are stored in the NAS device 1 as virtual machine resource files by the virtual machine monitor program 410, along with various other types of files using a network filesystem interface such as NFS, CIFS, and the like. The virtual machine resource files may include data that is necessary for the virtual machine to boot up and run, such as a virtual disk file, a virtual memory file, and the like. A virtual disk file may contain operating system data, system configuration data, system log data, application programs that run on the virtual machine 411 to provide specific services, application data, and so forth. As a result, a virtual machine 411 may have a lot of files packed within it. This characteristic allows a virtual machine 411 to have portability, so that the virtual machine 411 can be easily moved from one host computer to another host computer for various reasons (e.g., load balancing, high availability, and so forth). In this embodiment, the server management program 710 on the host computer 7 can request the virtual machine monitor program 410 to transfer a virtual machine 411. The virtual machines 411 can also be migrated to physical host computers and vice versa. For example, an administrator can move contents of a hard disk in a certain physical host computer to a virtual disk and run the host computer as a virtual machine 411 to consolidate server. On the other hand, the security check system or the data archive system are not designed to recognize each virtual machine resource file, analyze format of each virtual machine resource file, and handle files contained within the virtual machine resource files.

As seen in FIG. 1, the host computer 5 is a security server that provides security-related services in the network. In this embodiment, the host computer 5 performs security checks against data stored in the NAS device 1. Security check service can use network filesystem client capability provided by the operating system of the host computer 5 to access data stored in the NAS device 1. To achieve this purpose, it needs to properly refer to files contained within the virtual machine resource files as well as ordinary files. According to an aspect of the invention, the NAS device 1 allows the host computer 5 to directly access to contents of these files using an ordinary network filesystem interface.

The host computer 5 includes at least one CPU 50, at least one memory 51, and at least one network interface 52. Software programs run on the host computer 5. The programs and information used by the programs are stored in the memory 51. The CPU 50 executes the programs. The security monitoring program 510 provides a certain kind of security service. In this embodiment, it performs virus scanning for files stored in the NAS device 1, which include files contained within the virtual machine resource files.

The host computer 6 is a data archive server that provides data archiving service. Data archiving service can use network filesystem client capability provided by the operating system of the host computer 6 to access data stored in the NAS device 1. To achieve this purpose, it needs to properly refer to files contained within the virtual machine resource files as well as ordinary files. According to an aspect of the invention, the NAS device 1 allows the host computer 6 to directly access contents of these files using an ordinary network filesystem interface and create additional information for archived files based on their contents. The host computer 6 includes at least one CPU 60, at least one memory 61, and at least one network interface 62. Software programs run on the host computer 6. The programs and information used by the programs are stored in the memory 61. The CPU executes the programs. The data archive program 610 provides data archiving service. In this embodiment, it retrieves files stored in the NAS device 1 and archives them into the data archive storage device 2. It can also create additional information for archived files.

The host computer 7 is a server management device that manages other servers including both physical host computers and virtual machines running on host computers. The host computer 7 includes at least one CPU 70, at least one memory 71, and at least one network interface 72. Software programs run on the host computer 7. The programs and information used by the programs are stored in the memory 71. The CPU 70 executes the programs. The server management program 710 provides an interface that allows an administrator to manage and operate servers including both physical host computers and virtual machines running on host computers. For example, an administrator can move a virtual machine from one host computer to another host computer via the server management program 710 to achieve load balancing, high availability, and the like. The server management program 710 can also automatically move virtual machines. When a server is moved because of virtual machine movement or migration, the server management program 710 updates the resource view control table 114 via the management agent program 111 so that the control table 114 indicates correct location information and resource information of each server.

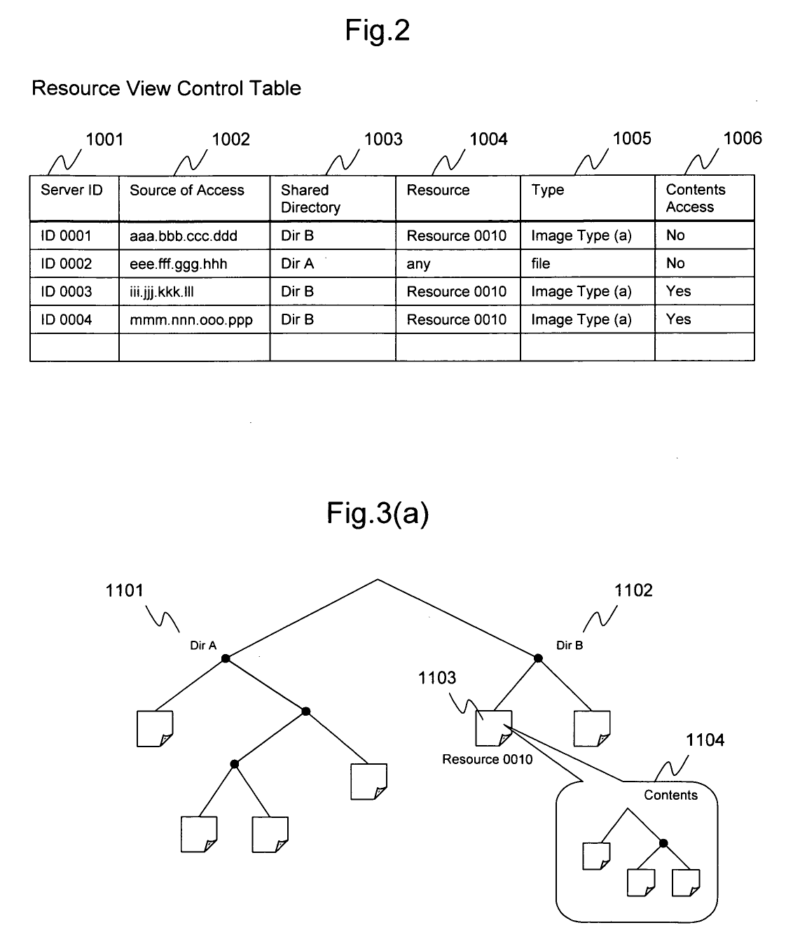

FIG. 2 illustrates an example of the data structure of the resource view control table 114. The server ID 1001 indicates unique identification information of each server which can be either a physical host computer or a virtual machine. The server ID can be assigned to each host computer and managed by the server management program 710. The source of access 1002 indicates unique identification information of each server identified by the server ID. There could be various types of information which can be used for this, such as network identification information, network filesystem authentication information, and so forth. In this embodiment, it uses the IP address of each server. The shared directory entry 1003 indicates unique identification information of each shared directory that is exported to servers on the NAS device 1. The resource name or entry 1004 indicates identification information of one or more files stored in each shared directory of the NAS device 1. The type entry 1005 indicates the type of file identified by the resource entry 1004. In this embodiment, if it is just a “file,” the network filesystem service program 110 treats an access from a server identified by the server ID 1001 and the source of access 1002 to a file identified by the resource entry 1004 in a shared directory identified by the shared directory 1003 as an ordinary file, and the host computer can retrieve the file. If it indicates a certain type of virtual machine resource files, the resource view control program 112 can load a proper resource drive module 113. The content(s) access entry 1005 indicates whether a server needs to directly refer to files contained within a virtual machine resource file identified by the resource entry 1004 or not.

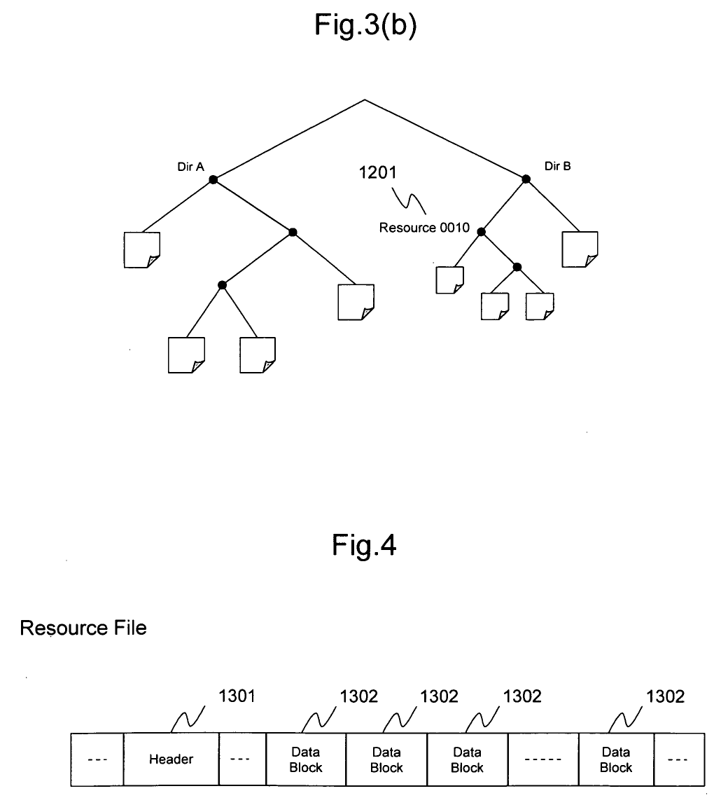

FIGS. 3a and 3b show example structures of the filesystem in a network attached storage (NAS) device. The NAS device 1 can export a part of its filesystem using a network filesystem service protocol such as NFS, CIFS, and the like. In this example, the NAS device 1 exports parts of its filesystem as shared directories so that servers, which may be either a physical host computer or a virtual machine, can store resources including virtual machine resource files.

In FIG. 3(a), the NAS device 1 has two shared directories named “Dir A” and “Dir B.” “Dir B” contains a virtual disk file named “Resource 0010.” When the NAS device 1 receives an access request from the host computer 4 (virtualization server) to “Dir B,” it will show the “Resource 0010” as just a file. On the other hand, when the NAS device 1 receives an access request from the host computer 5 (security server) or the host computer (data archive server) 6 to “Dir B,” it will mount the virtual disk file and show it as a directory named “Resource 0010” under “Dir B” so that the host computer 5 or 6 can directly refer to the files contained within the virtual disk file.

The shared directory 1101 (Dir A) is one of the shared directories which the NAS device 1 exports to the servers. The shared directory 1102 (Dir B) is another one of the shared directories which the NAS device exports to the servers. In this example, one of the virtual disk files is stored in this directory for one of the virtual machines running on the host computer 4. The resource 1103 is one of the virtual machine resource files. In this example, it is one of the virtual disk files for one of the virtual machines running on the host computer 4. The content 1104 indicates that the resource 1103 contains files and filesystem within it.

FIG. 3(b) shows an example structure of filesystem in the NAS device 1 after it mounted the virtual disk file named “Resource 0010” as a directory named “Resource 0010” under the shared directory named “Dir B.” The resource 1201 is a directory to which the NAS device 1 mounts a virtual disk file.

FIG. 4 shows an example structure of a virtual disk file which is a type of virtual machine resource files. The header 1301 contains information that is necessary to properly handle the data block 1302. For example, it can contain a time stamp, disk size, data block length, data checksum, identification information of a server, and so forth. The data block 1302 is a unit of data out of the virtual hard disk. A virtual hard disk can consist of multiple data blocks.

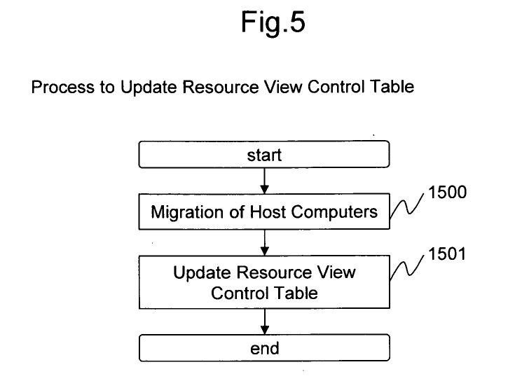

FIG. 5 illustrates an exemplary process for updating the resource view control table. In the embodiment, the updating is performed by the server management program 710 and the management agent program 111. In this example, an administrator makes the host computer 3 migrate to one of the virtual machines 411 running on the host computer 4, and updates the resource view control table 114.

In step 1500, an administrator makes a virtual machine from the host computer 3 using a migration tool. In the example, a virtual disk file is newly created under a shared directory in the NAS device 1. Files, which have been used by the host computer 3, are copied into the virtual disk file. In step 1501, the administrator updates the resource view control table 114 within the NAS device 1 using a server management interface provided by the server management program 710 and the management agent program 111 so that the equivalent entry of the server indicates a new source of access 1002, a newly created virtual disk file as a resource with a resource entry 1004, and a shared directory 1003 containing the virtual disk file.

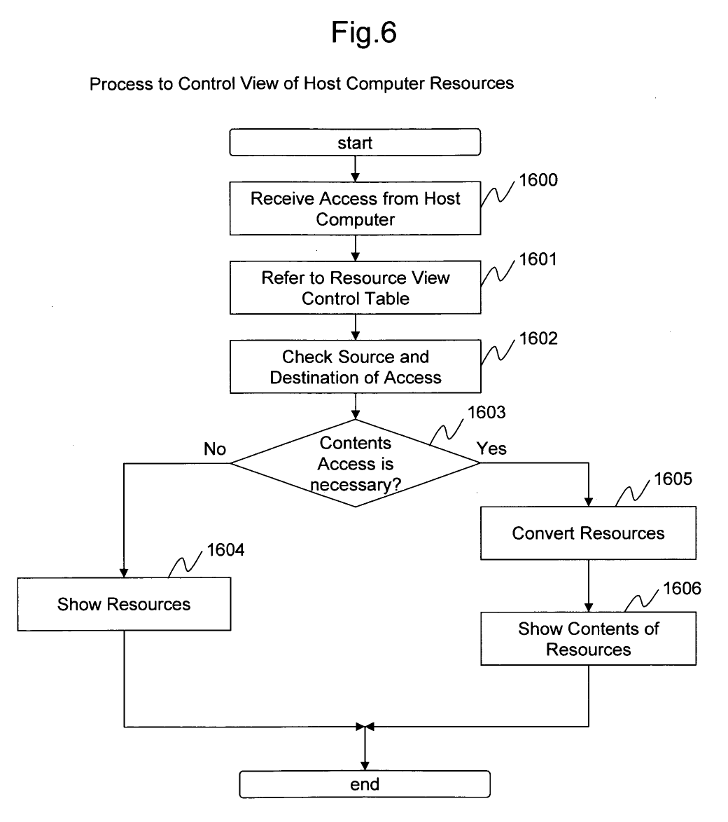

FIG. 6 illustrates an exemplary process for controlling the view of resources. In the embodiment, the process is performed by the NAS device 1. In this example, one of the servers, which can be either a physical host computer or a virtual machine, tries to access a shared directory in the NAS device 1.

In step 1600, the network filesystem service program 110 receives an access request from a server to a certain shared directory on the NAS device 1. In step 1601, the network filesystem service program 110 refers to the resource view control table 114. The program 110 may do so when it starts or when the table is updated as well. In step 1602, the network filesystem service program 110 checks the source and destination of the access request to see which server is trying to access files in which directory, and find a row in the table 114 that contains the equivalent or corresponding source of access 1002 and shared directory 1003. In step 1603, the network filesystem service program 110 checks the resource entry 1004 and content access entry 1006 in the resource view control table 114 to identify the files in which it needs to show contained files. If there is any file for which the content access entry 1006 indicates the necessity of showing contained files, the process proceeds to step 1605. Otherwise, the process proceeds to step 1604. In step 1604, the network filesystem service program 110 shows a list of files contained in the shared directory. In step 1605, the network filesystem service program 110 invokes the resource view control program 112. The resource view control program 112 refers to the resource type information 1005 in the resource view control table 114, and loads a proper resource driver module 113. The resource view control program 112 mounts a file under the shared directory. In step 1606, the network filesystem service program 110 shows a list of files contained in the shared directory. A virtual machine resource file is shown as a directory under the shared directory. It should be noted that a server, which can be either a physical host computer or a virtual machine, also can specify a certain resource name and directly access the file under a certain shared directory as well.

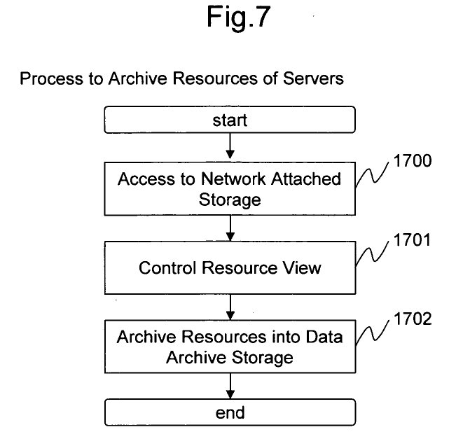

FIG. 7 illustrates an exemplary process for archiving resources of servers within the network attached storage device into the data archive storage device. The data archive program 610 on the host computer 6 retrieves files from the NAS device 1 and archives them into the data archive storage device 2.

In step 1700, the data archive program tries to access a certain shared directory in the NAS device 1. In step 1701, the NAS device 1 performs a process to control the view of the server resources as described in FIG. 6. In step 1702, the data archive program 610 retrieves files, which can be files contained in a certain virtual resources, and archives them into the data archive storage 2. In addition, the security monitoring program 510 can also perform security checks for files contained in a certain virtual machine resource file as well as the data archive program 610.

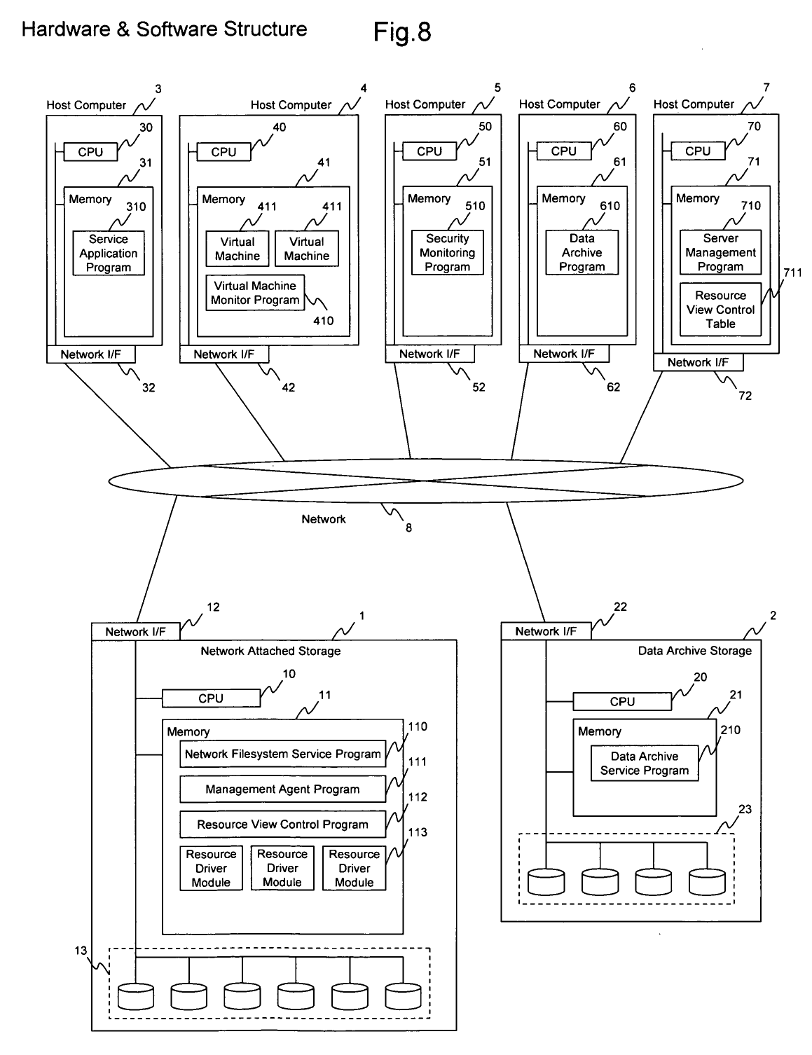

FIG. 8 illustrates an example of the hardware and software structure of a storage system according to another embodiment of the present invention. In the embodiment of FIG. 1, the NAS device 1 contains the resource view control table 114. In the embodiment of FIG. 8, the resource view control table 114 is managed and stored in the host computer 7 to centralize resource view control information. The NAS device 1 can request resource view control information from the server management program 710. This centralized approach is advantageous in systems having multiple NAS devices. Each NAS device will request resource view control information from the server management program 710.

In FIG. 8, the network filesystem service program 110 asks the server management program 710 via the management agent program 111 to check the resource view control table 711 and invokes the resource view control program 112, if it receives an access request from a server to a virtual machine resource file or a shared directory containing virtual machine resource file(s) and the server needs to directly access files contained within a virtual machine resource file as defined in the resource view control table 711. The management agent program 111 provides an interface that allows the network filesystem management program 710 to check the resource view control information of the resource view control table 711 within the host computer 7. In this embodiment, the resource view control program 112 asks the server management program 710 via the management agent program 111 to check the resource view control table 711 to identify the type of the virtual machine resource file.

In the embodiment of FIG. 8, the host computer 7 is one of the servers and is provided for managing other servers including both physical host computers and virtual machines running on host computers. Further, the host computer 7 manages the resource view control information of the virtual machine resource files.

The server management program 710 provides an interface that allows an administrator to manage and operate servers including both physical host computers and virtual machines running on host computers. For example, an administrator can move a virtual machine from one host computer to another host computer via the server management program 710 to achieve load balancing, high availability, and the like. The server management program 710 can also automatically move virtual machines. When a server is moved because of virtual machine movement or migration, the server management program 710 updates the resource view control table 711 within the host computer 7 so that the table 711 indicates correct location information and resource information of each server. It also provides an interface that allows the NAS device 1 to check resource view control information.

The resource view control table 711 defines the resource view control information that is set by an administrator via the server management program 710. The resource view control information is used by the network filesystem service program 110 and the resource view control program 112 via the server management program 710 and the management agent program 111. When the NAS device 1 receives an access request from a server to a file stored within it, the network filesystem service program 110 asks the server management program 710 via the management agent program 111 to check this table 711 to determine whether the NAS device 1 should show files contained within the virtual machine resource to the server.

The data structures in the embodiment of FIG. 8 are the same as those in the embodiment of FIG. 1 except for the location of the resource view control table 711.

The embodiment of FIG. 8 may employ the same processes as those for the embodiment of FIG. 1 to update the resource view control table 711 (FIG. 5), to control the view of the host computer resources (FIG. 6), and to archive the resources of the servers (FIG. 7).

In the process of FIG. 5 as applied to the embodiment of FIG. 8, the resource view control table 711 is updated by the server management program 710. In this example, an administrator makes the host computer 3 migrate to one of the virtual machines 411 running on the host computer 4 and updates the resource view control table 711. In step 1501, the administrator updates the resource view control table 711 within the host computer 7 using a server management interface provided by the server management program 710 so that the equivalent entry of the server indicates a new source of access 1002, a newly created virtual disk file as a resource with a resource entry 1004, and a shared directory 1003 containing the virtual disk file.

In the process of FIG. 6 as applied to the embodiment of FIG. 8, the network filesystem service program 110 receives an access request from a server to a certain shared directory on the NAS device 1 in step 1600. In step 1601, the network filesystem service program 110 asks the server management program 710 via the management agent program 111 to check the resource view control table 711. In step 1602, the server management program 710 checks the source and destination of the access request to see which server is trying to access files in which directory, and find a row in the table 711 that contains the equivalent or corresponding source of access 1002 and shared directory 1003. In step 1603, the server management program 710 checks the resource entry 1004 and content access entry 1006 in the resource view control table 711 to identify the files in which the NAS device 1 needs to show contained files. If there is any file for which the content access entry 1006 indicates the necessity of showing contained files, the process proceeds to step 1605. Otherwise, the process proceeds to step 1604. In step 1604, the server management program 710 sends the result of checking the resource view control information to the network filesystem service program 110. The network filesystem service program 110 invokes the resource view control program 112. The resource view control program 112 asks the server management program 710 via the management agent program 111 to retrieve the resource type information 1005 in the resource view control table 711 and loads a proper resource driver module 113. The resource view control program 112 mounts a file under the shared directory.

In the process of FIG. 7 as applied to the embodiment of FIG. 8, the NAS device 1 and the host computer 7 perform a process to control view of server resources as described in FIG. 6. In step 1702, the data archive program 610 retrieves files, which can be files contained in a certain virtual resources, and archives them into the data archive storage 2.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for extracting machine resource files based on sources of accesses by controlling the view of the resources. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A storage system comprising:
a network attached storage (NAS) device which is connected to a plurality of computer devices via a network, the NAS device being configured,
(i) in response to a request to access a virtual machine resource which is recognized by the NAS device through identification information associated with the request as one that does not require content access to the virtual machine resource, to show the virtual machine resource without content access; and
(ii) in response to a request to access a virtual machine resource from which is recognized by the NAS device through identification information associated with the request as one that requires content access to the virtual machine resource, to show the virtual machine resource with content access through which the computer device can directly refer to one or more files contained within the virtual machine resource.

2. A storage system according to claim 1,
wherein the request which does not require content access to the virtual machine resource is sent from a computer device or a part of a computer device that provides a server virtualization platform.

3. A storage system according to claim 1,
wherein the request which requires content access to the virtual machine resource is sent from a computer device or a part of a computer device that provides a service selected from the group consisting of data archiving and security checking.

4. A storage system according to claim 1,
wherein the NAS device includes a resource view control table which stores information on whether to show the virtual machine resource with content access or without content access for each of the plurality of computer devices connected to the NAS device; and
wherein the NAS device refers to the resource view control table to determine whether to show the virtual machine resource with content access or without content access in response to a request from any of the plurality of computer devices.

5. A storage system according to claim 4,
wherein the resource view control table further stores information to show data other than virtual machine resource without content access in response to a request from any of the plurality of computer devices.

6. A storage system according to claim 4,
wherein one of the plurality of computer devices connected to the NAS device via the network is a management computer device which is configured to update the resource view control table in response to a change in status of any of the plurality of computer devices.

7. A storage system according to claim 6,
wherein one of the plurality of computer devices is a physical computer device which is made into a virtual machine by migration, a new virtual machine resource is created in the NAS device, and resource used by the physical computer device is copied into the new virtual machine resource; and
wherein the management computer device updates the resource view control table to indicate a change in status of the resource from the resource used by the physical computer device to the new virtual machine resource.

8. A storage system according to claim 1,
wherein one of the plurality of computer devices connected to the NAS device via the network is an archive computer device which is configured to access one or more resources in the NAS device;
wherein the NAS device is configured to show a resource to be accessed by the archive computer device without content access if the resource is data other than virtual machine resource, and to show a resource to be accessed by the archive computer device with content access if the resource is a virtual machine resource.

9. A storage system according to claim 1,
wherein one of the plurality of computer devices connected to the NAS device via the network is a management computer device which is configured to provide resource view control information to the NAS device specifying whether to show the virtual machine resource with content access or without content access for each of the plurality of computer devices connected to the NAS device.

10. A storage system according to claim 9,
wherein the management computer device includes a resource view control table that stores information on whether to show the virtual machine resource with content access or without content access for each of the plurality of computer devices connected to the NAS device; and
wherein the management computer device is configured to update the resource view control table in response to a change in status of any of the plurality of computer devices.

11. A storage system comprising:
a network attached storage (NAS) device which is connected to a plurality of computer devices via a network, the NAS device including a virtual machine resource and data other than virtual machine resource;
wherein, in response to a request to access the virtual machine resource which is recognized by the NAS device through identification information associated with the request as one that does not require content access to the virtual machine resource, the request being sent from a computer device or a part of a computer device that provides a server virtualization platform, the NAS device is configured to show the virtual machine resource without content access;
wherein, in response to a request to access the virtual machine resource which is recognized by the NAS device through identification information associated with the request as one that requires content access to the virtual machine resource, the NAS device is configured to show the virtual machine resource with content access through which the computer device can directly refer to one or more files contained within the virtual machine resource; and
wherein, in response to a request to access data other than virtual machine resource from any of the plurality of computer devices, the NAS device is configured to show the data without content access.

12. A storage system according to claim 11,
wherein the NAS device includes a resource view control table which stores information on whether to show the virtual machine resource with content access or without content access for each of the plurality of computer devices connected to the NAS device; and
wherein the NAS device refers to the resource view control table to determine whether to show the virtual machine resource with content access or without content access in response to a request from any of the plurality of computer devices.

13. A storage system according to claim 12,
wherein one of the plurality of computer devices connected to the NAS device via the network is a management computer device which is configured to update the resource view control table in response to a change in status of any of the plurality of computer devices.

14. A storage system according to claim 12,
wherein one of the plurality of computer devices is a physical computer device which is made into a virtual machine by migration, a new virtual machine resource is created in the NAS device, and files used by the physical computer device are copied into the new virtual machine resource; and
wherein the management computer device updates the resource view control table to indicate a change in status of the resource from the files used by the physical computer device to the new virtual machine resource.

15. A storage system according to claim 11,
wherein one of the plurality of computer devices connected to the NAS device via the network is a management computer device which is configured to provide resource view control information to the NAS device specifying whether to show the virtual machine resource with content access or without content access for each of the plurality of computer devices connected to the NAS device.

16. A storage system according to claim 15,
wherein the management computer device includes a resource view control table that stores information on whether to show the virtual machine resource with content access or without content access for each of the plurality of computer devices connected to the NAS device; and
wherein the management computer device is configured to update the resource view control table in response to a change in status of any of the plurality of computer devices.

17. A method of controlling view of resources in a network attached storage (NAS) device for a storage system in which a plurality of computer devices are connected to the NAS device via a network, the method comprising:
in response to a request to access a virtual machine resource which is recognized by the NAS device through identification information associated with the request as one that does not require content access to the virtual machine resource, showing the virtual machine resource without content access; and
in response to a request to access a virtual machine resource which is recognized by the NAS device through identification information associated with the request as one that requires content access to the virtual machine resource, showing the virtual machine resource with content access through which the computer device can directly refer to one or more files contained within the virtual machine resource.

18. A method according to claim 17, further comprising
providing in the NAS device a resource view control table which stores information on whether to show the virtual machine resource with content access or without content access for each of the plurality of computer devices connected to the NAS device; and
referring to the resource view control table to determine whether to show the virtual machine resource with content access or without content access in response to a request from any of the plurality of computer devices.

19. A method according to claim 18, further comprising
in response to a request to access data other than virtual machine resource from any of the plurality of computer devices, showing the data without content access.

20. A method according to claim 18, further comprising
updating the resource view control table in response to a change in status of any of the plurality of computer devices.

21. A method according to claim 17, further comprising
obtaining, from a management computer device which is connected to the NAS device via the network, resource view control information specifying whether to show the virtual machine resource with content access or without content access for each of the plurality of computer devices connected to the NAS device.

22. A method according to claim 21, wherein obtaining the resource view control information comprises
accessing a resource view control table in the management computer device, the resource view control table storing information on whether to show the virtual machine resource with content access or without content access for each of the plurality of computer devices connected to the NAS device; and
referring to the resource view control table to determine whether to show the virtual machine resource with content access or without content access in response to a request from any of the plurality of computer devices.
